(19) United States
(12) Patent Application Publication
(10) Pub. No.: US 2021/0035103 A1
(43) Pub. Date: Feb. 4, 2021

(54) METHODS AND SYSTEMS FOR IDENTIFYING ELECTRONIC TRANSACTION ROUTING ANOMALY

(71) Applicants: Shilpi Agrawal, Bangalore (IN); Arpita Dutta, Bangalore (IN); Animesh Tripathy, Bangalore (IN); Prameela Kavya Thummuru, Bangalore (IN); Vijayendra Singh, Bangalore (IN)

(72) Inventors: Shilpi Agrawal, Bangalore (IN); Arpita Dutta, Bangalore (IN); Animesh Tripathy, Bangalore (IN); Prameela Kavya Thummuru, Bangalore (IN); Vijayendra Singh, Bangalore (IN)

(21) Appl. No.: 16/525,127

(22) Filed: Jul. 29, 2019

(51) Int. Cl. G06Q 20/40; G06Q 20/26

(52) U.S. Cl. CPC G06Q 20/4012; G06Q 20/26

(57) ABSTRACT

A method for detecting debit PIN routing may include receiving a first dataset and a second dataset for a merchant during a first time period. The first dataset may include credit transaction amount and the second dataset may include debit PIN transaction amount for the merchant during the first time period. A first ratio and a second ratio using the first dataset may be determined, and a third ratio and a fourth ratio using the second dataset may be determined. A first threshold value and a second threshold value using the first dataset may be calculated. Once the first, second, third and fourth ratios and the first and second threshold values are calculated, debit PIN routing behavior may be determined by comparing the first ratio to the first threshold value and comparing the second ratio to the second threshold value.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Credit and debit cards have increasingly become the preferred methods for consumers to pay for goods and services making these forms of electronic payments an indispensable way for big and small merchants to conduct business. Under certain government regulations, merchants are required to provide consumers with the option of a credit transaction or a debit PIN transaction at a point of sale (POS). Credit transactions can occur via a traditional credit card or a debit card with credit transaction capabilities. Credit transactions are routed through conventional electronic-fund-transfer (EFT) networks such as STAR®, Pulse®, NYCE®, MAC®, SHAZAM®, MasterCard's Maestro® and Visa's Interlink®, which have established transaction fees.

Debit PIN transactions can only occur via debit cards and require a consumer to enter a personal identification number (PIN) that is four to twelve digits long at the POS. Debit PIN transactions do not have to be routed through the same EFT networks as credit transactions. Instead, they can be routed through alternate channels that have lower transaction fees.

Given the lower transaction fees associated with debit PIN transactions, a merchant may unilaterally choose not to give consumers a choice of a credit transaction or a debit PIN transaction. Rather, the merchant may only provide the option of a debit PIN transaction and send the debit PIN transaction through a debit network of their choice rather than as a credit transaction. The debit PIN transactions are less expensive for the merchant because the merchants have a choice of routing the transaction among a number of competing networks. Debit PIN routing behavior occurs when a merchant routes its debit PIN transaction to some unaffiliated network instead of a conventional EFT network, resulting in lost transaction payment volume for the conventional EFT network processing company. In some scenarios, this debit PIN routing behavior may violate one or more regulatory, legal, and/or contractual requirements.

Thus, there exists a need to establish a framework that can effectively identify merchants exhibiting debit PIN routing behavior to safeguard the loss of revenue to conventional EFT network processing companies and assist conventional EFT network providers in enforcing compliance with regulations that provide for consumers choice.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, debit PIN routing behavior of a merchant may be detected. The method for detecting debit PIN routing may include receiving a first dataset and a second dataset for a merchant during a first time period. The first dataset may include credit transaction amount and the second dataset may include debit PIN transaction amount for the merchant during the first time period. The method may determine a first ratio and a second ratio using the first dataset. The method may also determine a third ratio and a fourth ratio using the second dataset. Further, the method may determine a first threshold value and a second threshold value using the first dataset. Once the first, second, third and fourth ratios and the first and second threshold values are calculated, debit PIN routing behavior may be determined by comparing the first ratio to the first threshold value and comparing the second ratio to the second threshold value. Debit PIN routing behavior may be determined to exist during a second time period if the first ratio is less than or equal to the first threshold value, ratio is less than or equal to the second threshold value, the third ratio is greater than 1, and the fourth ratio is greater than 1 during the second time period.

### BRIEF DESCRIPTION OF THE DRAWINGS

The example embodiment(s) of the present disclosure are illustrated by way of example, and not in way by limitation, in the figures of the accompanying drawings and in which like reference numerals refer to similar elements and in which:

FIG. 1 is a flowchart of a method for classifying a merchant;

FIG. 2 is a flowchart of a method for identifying debit PIN routing behavior;

FIG. 3 is a graph of credit and debit PIN transaction amount for each month for an example Merchant 1;

FIG. 4 is a graph of credit and debit PIN transaction amount for each month for an example Merchant 2;

FIG. 5 is a schematic illustration of elements of an example electronic transaction processing system; and,

FIG. 6 is a block diagram of system components of a computing device in accordance with the present disclosure.

The figures depict various embodiments for purposes of illustration only. One skilled in the art may readily recognize from the following discussion that alternative embodiments of the structures and methods illustrated herein may be employed without departing from the principles described herein. For example, other embodiments may omit, add to, reorder, and/or modify any of the elements shown in the figures.

### DETAILED DESCRIPTION

At a high level, the systems and methods described herein attempt to identify when a merchant has a perceptible or statically significant drop off in debit PIN transaction activity on a specific network which may indicate there is some unusual external or internal merchant behavior occurring. For example, a decline in debit PIN transaction amount may indicate that there are problems with the debit PIN system at the merchant, that fraudulent activity may be occurring at the merchant, that there has been a decline in all electronic transactions at the merchant, or that the merchant has changed or modified its debit transaction processing network in some way. In any case, it may be useful to investigate the reason for the decline in debit PIN transactions at the merchant to determine to source of the difference.

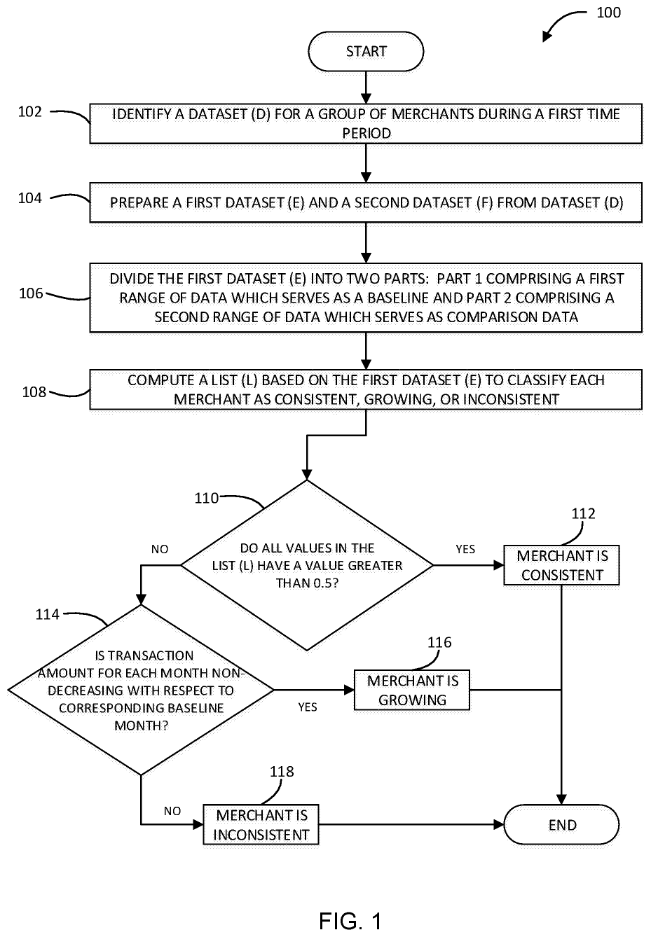

FIG. 1 generally illustrates an embodiment of a method 100 for classifying a merchant, which may be used to assist in determining whether a change in transaction amount has occurred over time. At a block 102, a dataset (D) for a group or plurality of merchants during a first time period may be identified. The group of merchants may be two or more merchants and may be selected or categorized based on industry or merchant type (e.g., grocery, retail, women/men clothing stores, pharmacy, drug store, etc.).

The dataset (D) may consist of overall transaction amount, credit transaction amount, and debit PIN transaction amount for the group of merchants for the first time period. The first time period may be, for example, a 6 month, 12 month, 18 month, or 24 month period of time, or any other period of time for which transaction amount, credit transaction amount, and debit PIN transaction amount is available for a group of merchants.

Once a dataset (D) is identified, two datasets may be prepared from dataset (D) for each merchant at a block 104. The two datasets may comprise a first dataset (E) and a second dataset (F) for each merchant. The first dataset (E) may consist of credit transaction amount for each merchant in the first time period and the second dataset (F) may consist of debit PIN transaction amount for each merchant in the first time period.

Once the first dataset (E) and the second dataset (F) are prepared, each merchant within the group of merchants may be categorized into one of three classifications. The classifications may include: Consistent Merchants, Growing Merchants, and Inconsistent Merchants.

Each merchant in the group of merchants may be classified based on a computation of a list (L). To compute the list (L), the first dataset (E) may be divided into two parts, a Part 1 and a Part 2, at a block 106. Part 1 may consist of data from dataset (E) during a first selected time frame and may be used as a baseline. Part 2 may consist of data from dataset (E) during a second selected time frame and may be used for observation or comparison. The first and second selected time frames may be non-overlapping and may be for a period of three months, six months, nine months, twelve months or any other period for which credit transaction amount is available and from which List (L) can be computed.

In an embodiment, the first time period may be a period of 24 months and the first and second selected time frames may each be for a period of 12 months. For example, the first dataset (E) and the second dataset (F) may comprise credit transaction and debit PIN transaction data, respectively, from a group of merchants for a period of 01/2015-12/2016. Thus, dividing the first dataset (E) into two parts may result in Part 1 comprising data from the first 12 months of the first dataset (E) (e.g., credit transaction amount from 01/2015-12/2015) and Part 2 may consist of data from the second 12 months of the first dataset (E) (e.g., 01/2016-12/2016).

Once Part 1 and Part 2 are determined, the list (L) may be computed at a block 108 using a rolling correlation between the data in Part 1 and the data in Part 2, with an incrementally increasing window size. For example, Part 1 may consist of data from a 12 month period. Thus, the window size may increase from a window size of 2 months to a window size of 12 months, increasing the window size by 1 month with each iteration. The list (L) may be computed using Pearson's Correlation coefficient, for example:

$${ρ}_{x , y} = \frac{cov ( x , y )}{{σ}_{x} {σ}_{y}}$$

Here, cov(x,y) may be the covariance between x and y, where x may be the credit transaction amount during a window in Part 1 and y may be the credit transaction amount during the same window in Part 2. In addition, σₓ may be the standard deviation of x, and the σ_{y} may be the standard deviation of y.

At a block 110, whether all the values in the list (L) for a merchant have a value greater than 0.5 may be determined. If all the values in a list (L) for a merchant are greater than 0.5, then the merchant may be classified as Consistent Merchant at a block 112.

If all the values in the list (L) for a merchant are not greater than 0.5, the method moves to a block 114. At block 114, whether the credit transaction amount in Part 1 is non-decreasing with respect to the corresponding baseline in Part 2 is determined. For example, if the credit transaction amount for each month in Part 2 is non-decreasing with respect to the credit transaction amount for the corresponding month in Part 1, then a merchant may be classified as a Growing Merchant at a block 116. Although a month time frame is used, any time frame (e.g., 1 day or 1 week) may be used as long as there is corresponding baseline data.

If a merchant is not Consistent and not Growing then the merchant may be classified as Inconsistent at a block 118. Because inconsistent behavior in merchants may be due to several external factors, merchants that may be classified as Consistent or Growing are eligible for debit PIN routing detection.

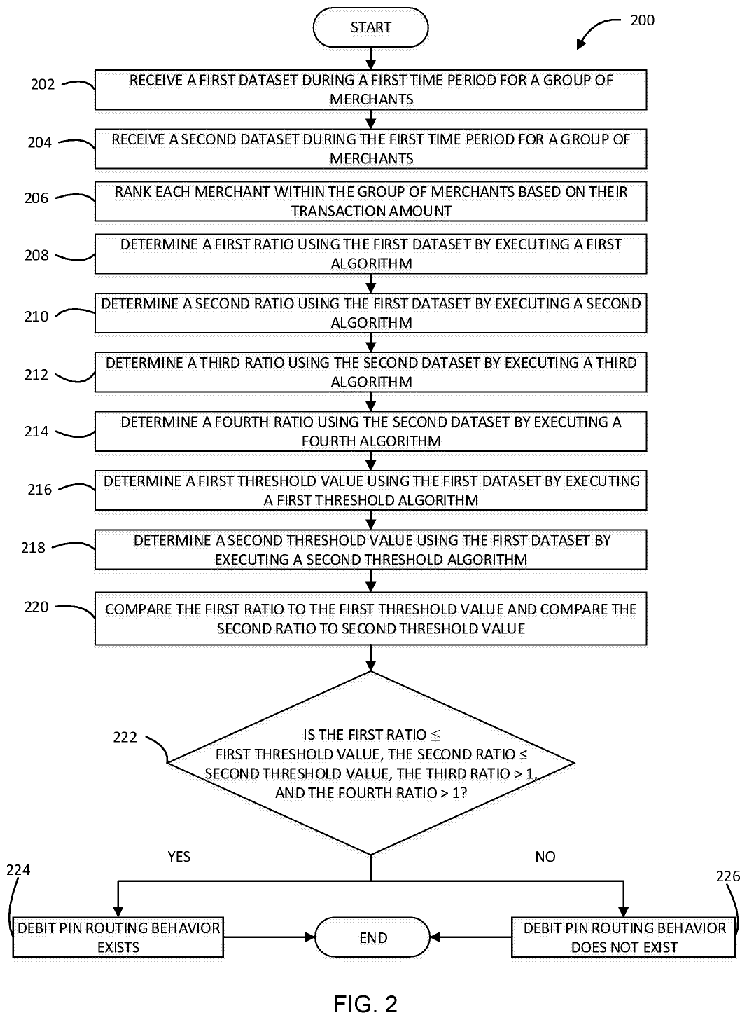

Once the Consistent and Growing merchants have been identified, debit PIN routing may be identified. FIG. 2 generally illustrates an embodiment of a method 200 for identifying debit PIN routing behavior.

At a block 202, a first dataset (E) may be received. The first dataset (E) may be credit transaction amount for a merchant (m) during a first time period. As mentioned earlier, the first time period may vary in length of time.

At a block 204 a second dataset (F) may be received. The second dataset (F) may be debit PIN transaction amount for the merchant (m) during the first time period.

In an embodiment, the first time period may be 24 months. The first 12 month period may serve as a baseline dataset for detection of debit PIN routing behavior in the second 12 month period. For example, dataset (D), the first dataset (E), and the second dataset (F) may include overall transaction amount, credit transaction amount, and debit PIN transaction amount, respectively, from 01/2015 to 12/2016. Each of the datasets (D), (E), and (F) may each be divided into two parts: Part 1, which serves as a baseline dataset, and Part 2 may be used for observation. Thus, the data in Part 1 may be used to determine a merchants' debit PIN routing behavior in Part 2.

Using the example provided above, Part 1 for each of dataset (D), the first dataset (E), and the second dataset (F), may consist of overall transaction amount, credit transaction amount, and debit PIN transaction amount, respectively, from 01/2015 to 12/2015. The baseline datasets for the first and second datasets (E) and (F) (Part 1) may then be used to determine a merchants' debit PIN behavior in period 01/2016 to 12/2016 (Part 2).

At a block 206, each merchant_{1, 2, . . . , n} within the group of merchants may be ranked in descending order based on their transaction amount in both the first dataset (E) and the second dataset (D). The ranking for dataset (E) may be based on a credit transaction amount for a second time period and the ranking for dataset (F) may be based on debit PIN transaction amount for the second time period. The second time period is less than the first time period. For example, the second time period can be a day, week, month, or more. In the above example, where the first time period is 24 months, the second time period may be one month.

For example, for the first dataset (E), each merchant_{1, 2, . . . , n} within the group of merchants may be ranked in descending order based on their credit transaction amount from rank 1 to rank n. And, for the second dataset (F), each merchant within the group of merchants may be ranked in descending order based on their debit PIN transaction amount from rank 1 to rank n. Thus, a merchant with a rank of 1 has the highest credit or debit PIN transaction amount for the second time period, and a merchant with a rank of n has the lowest credit or debit PIN transaction for the second time period. Thus, for example, if the first dataset (E) contains credit transaction amount for each merchant in the group of merchants for 24 months, then each merchant is ranked from 1 to n for each month in the 24 month period for dataset (E). The ranking process is then repeated for dataset (F).

At a block 208, a first ratio (a) may be determined using the first dataset (E). The first ratio (a) may be calculated for each merchant in the group of merchants using a first algorithm, for example:

$$a = \frac{{E}_{i ( m )}}{{E}_{i - 1 ( m )}}$$

Here Eᵢ₍ₘ₎ may be a rank of the merchant (m) during a third time period i in the first dataset (E), and Eᵢ₋₁₍ₘ₎ may be the rank of the merchant (m) for the prior period i. In an embodiment, the third time period i may be a month. In other embodiments, the third time period i may be a day, a week, or any other time frame for which sufficient and statistically meaningful credit transaction data is available for a group of merchants.

In one embodiment, Eᵢ₍ₘ₎ may be the rank of the merchant (m) during the second month of Part 2 of the first dataset (E), and Eᵢ₋₁₍ₘ₎ may be the rank of the merchant (m) during the first month of Part 2 of the first dataset (E). Using the example above, Eᵢ₍ₘ₎ may be the rank of merchant (m) based on credit transaction amount in month 08/2016 and Eᵢ₋₁₍ₘ₎ may be the rank of merchant (m) based on credit transaction amount in month 07/2016.

At a block 210, a second ratio (b) may be determined using the first dataset (E). The second ratio (b) may be calculated for each merchant in a group of merchants using a second algorithm, for example:

$$b = \frac{{E}_{i ( m )}}{{E}_{s m p y ( m )}}$$

Here, Eᵢ₍ₘ₎ may again be a rank of the merchant (m) for the third time period i in the first dataset (E). E_{smpy(m)} may be a rank of the merchant (m) for the same time period i in a previous time frame in the first dataset (E). In an embodiment, the third time period i may be a month and the previous time frame may be the previous 12 months.

In one embodiment, Eᵢ₍ₘ₎ may be the rank of the merchant (m) during the second month of Part 2 of the first dataset (E), and E_{smpy(m)} may be the rank of the merchant (m) during the second month of Part 1 of the first dataset (E). Using the example above, Eᵢ₍ₘ₎ may be the rank of merchant (m) based on credit transaction amount in month 08/2016 and E_{smpy(m)} may be the rank of merchant (m) based on credit transaction amount in month 08/2015.

At a block 212, a third ratio (c) may be determined using the second dataset (F). The third ratio (c) may be calculated for each merchant in the group of merchants using a third algorithm:

$$c = \frac{{F}_{i ( m )}}{{F}_{i - 1 ( m )}}$$

Here Fᵢ₍ₘ₎ is a rank of the merchant (m) for the third time period i in the second dataset (F), and Fᵢ₋₁₍ₘ₎ may be the rank of the merchant (m) for the prior period i. As noted above, the third time period i may be a month. In other embodiments, the third time period i may be a day, a week, or any other time frame for which credit transaction data is available for a group of merchants.

In one embodiment, Fᵢ₍ₘ₎ may be the rank of the merchant (m) during the second month of Part 2 of the second dataset (F) and Fᵢ₋₁₍ₘ₎ may be the rank of the merchant (m) during the first month of Part 2 of second dataset (F). Using the example above, Fᵢ₍ₘ₎ may be the rank of merchant (m) based on debit PIN transaction amount in month 08/2016 and Fᵢ₋₁₍ₘ₎ may be the rank of merchant (m) based on debit PIN transaction amount in month 07/2016.

At a block 214, a fourth ratio (d) may be determined using the second dataset (F). The third ratio (d) may be calculated for each merchant in the group of merchants as follows:

$$d = \frac{{F}_{i ( m )}}{{F}_{smpy ( m )}}$$

Here Fᵢ₍ₘ₎ is a rank of the merchant (m) for the third time period i in the second dataset (F). F_{smpy(m)} may be a rank of the merchant (m) for the same time period i in a previous time frame in the second dataset (F). In an embodiment, the third time period i may be a month and the previous time frame may be the previous 12 months.

In one embodiment, Fᵢ₍ₘ₎ may be the rank of the merchant (m) during the second month of Part 2 of the second dataset (F), and F_{smpy(m)} may be the rank of the merchant (m) during the second month of Part 1 of the second dataset (F). Using the example above, Fᵢ₍ₘ₎ may be the rank of merchant (m) based on debit PIN transaction amount in month 08/2016 and F_{smpy(m)} may be the rank of merchant (m) based on debit PIN transaction amount in month 08/2015.

At a block 216, a first threshold value may be determined using the first dataset (E). The first threshold value may be determined using a first threshold algorithm for a group of merchants:

$$first threshold value = mean ( \frac{{E}_{i}}{{E}_{i - 1}} ) + {σ}_{\frac{{E}_{i}}{{E}_{i - 1}}}$$

### Here

$$mean ( \frac{{E}_{i}}{{E}_{i - 1}} )$$

is the mean of the first ratio (a) for the plurality of merchants, and

$${σ}_{\frac{{E}_{i}}{{E}_{i - 1}}}$$

is the standard deviation of the first ratio (a) for the plurality of merchants.

At a block 218, a second threshold value may be determined using the first dataset (E). The second threshold value may be determined using a second threshold algorithm for a group of merchants:

$$second threshold value = mean ( \frac{{E}_{i}}{{E}_{smpy}} ) + {σ}_{\frac{{E}_{i}}{{E}_{smpy}}}$$

### Here

$$mean ( \frac{{E}_{i}}{{E}_{smpy}} )$$

is the mean of the second ratio (b) for the plurality of merchants, and

$${σ}_{\frac{{E}_{i}}{{E}_{smpy}}}$$

is the standard deviation of the second ratio (b) for the plurality of merchants.

At a block 220, the first ratio (a) may be compared to the first threshold value and the second ratio (b) may be compared to the second threshold value. At a block 222, whether the first ratio (a) is less than or equal to the first threshold value, the second ratio (b) is less than or equal to the second threshold value, the third ratio (c) is greater than 1, and the fourth ratio (d) is greater than 1 may be determined. If the first ratio (a) is less than or equal to the first threshold value, the second ratio (b) is less than or equal to the second threshold value, the third ratio (c) is greater than 1, and the fourth ratio (d) is greater than 1, then debit PIN behavior may exist in a second time period at a block 224. In one embodiment the second time period may be a month, however, other time frames are contemplated.

If any one condition is not met, then it may be inconclusive as to whether debit PIN routing behavior exists. However. if the first ratio (a) is greater than the first threshold value, the second ratio (b) is greater than second threshold value, the third ratio (c) is less than or equal to 1, and the fourth ratio (d) is less than or equal to 1, then at a block 224 debit PIN routing behavior may not exist during the second time period.

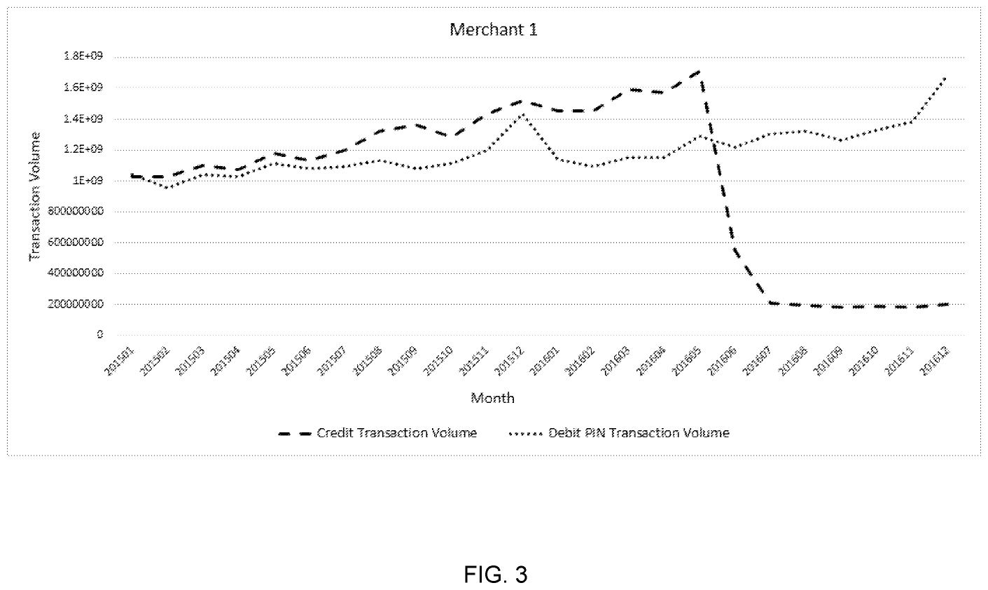

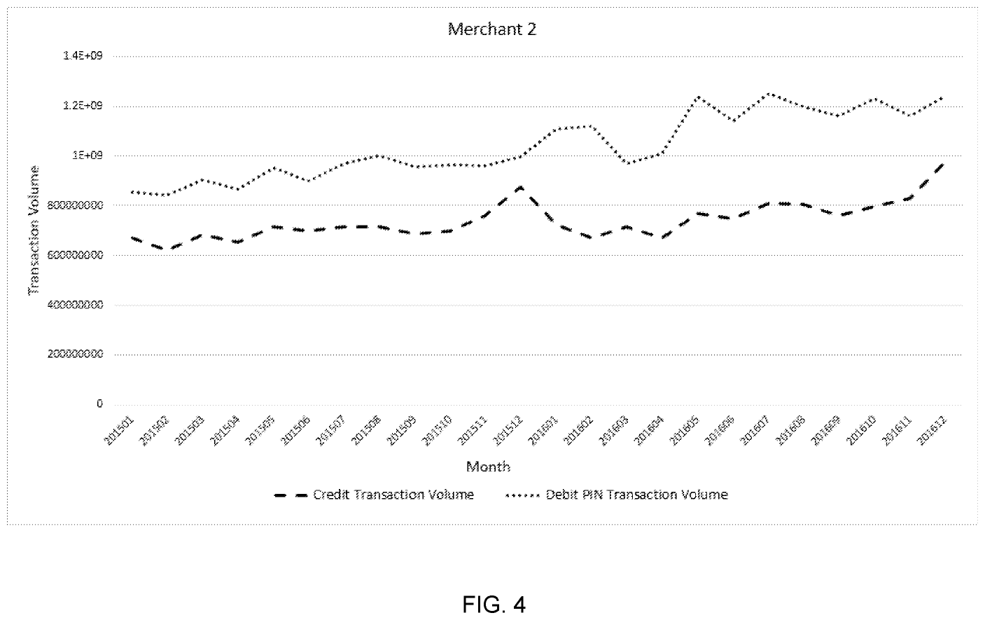

Turning to FIGS. 3 and 4, aspects of a dataset (D) for a group of merchants during a first time period in a merchant category are illustrated. The dataset (D) includes overall transaction amount, credit transaction amount, and debit PIN transaction amount for all the merchants in a group of 331 merchants for a first time period of 24 month period from 01/2015 to 12/2016, month 1 to month 24.

The procedure for detecting debit PIN routing behavior during a second time period begins by determining which merchants from the group of merchants are candidates for debit PIN routing behavior. From the dataset (D), two datasets for each merchant are prepared: a first dataset (E) consisting of credit transaction amount and a second dataset (F) consisting of debit PIN transaction for the merchant during a first time period.

For example, FIG. 3 shows credit transaction amount (dataset (E)) and debit PIN transaction amount (dataset (F)) for a Merchant 1 from a group of merchants for a first time period, where the first time period is a 24 month period from 01/2015 to 12/2016. FIG. 4 shows credit transaction amount, first dataset (E), and debit PIN transaction amount, second dataset (F), for a Merchant 2 from the group of merchants for the first time period (e.g., 01/2015 to 12/2016).

As shown in FIG. 3, there is a significant decrease in debit PIN transaction amount as compared to credit transaction amount for Merchant 1 around the time period of 07/2016. Therefore, Merchant 1 is a candidate for debit PIN routing detection. FIG. 4, on the other hand, shows similar credit and debit PIN transaction data for Merchant 2. Therefore, Merchant 2 is not a candidate for debit PIN routing behavior.

Once the merchants that may exhibit debit PIN routing behavior are determined (e.g., Merchant 1) the process for determining debit PIN routing behavior in a second time period begins by preparing from the dataset (D) a first dataset (E) for Merchant 1, which consists of credit transaction amount for Merchant 1 during the period 01/2015 through 12/2016 and a second dataset (F) for Merchant 1, which consists of debit PIN transaction amount from the dataset (D). The first dataset (E) for Merchant 1 is divided into two parts: Part 1 consists of data from 01/2015-12/2015 and Part 2 consists of data from 01/2016-12/2016. Part 1 and Part 2 are then used to compute a List (L) using the equation. Here the window size increases from a window size of 2 to a window size of 12, where the window size increases by 1 month with each iteration.

In the example embodiment, List (L) for Merchant 1 may be as follows:

L=[1.0, 0.944911182523068, 0.7902912368010209, 0.918073563358926, 0.9929201714702197, 0.9930752110531497, 0.9846523999672172, 0.9815264459235116, 0.9799189511960936, 0.981897244534997, 0.976862478961631].

Since all the values in List (L) for Merchant 1 have a value greater than 0.5, Merchant 1 may be classified as a Consistent Merchant and may be eligible for debit PIN routing detection.

The next part of the process for identifying whether Merchant 1 exhibits debit PIN routing behavior may be to rank each merchant in the group of merchants (e.g., Merchant 1 through Merchant 331) in descending order for each month i with respect to credit transaction amount and debit PIN transaction amount. A rank of 1 in a month i means that a particular merchant had the highest transaction amount in month i, and a rank of 331 means that a merchant had the lowest transaction amount in month i. Thus, an increase in rank signifies a decrease in transaction amount. In addition, if a merchant has consistent performance in debit PIN transaction amount ranks accompanied by increase rank in credit transaction data then the merchant has potential debit pin routing behavior.

Once the ranking is completed, the first ratio (a), the second ratio (b), the third ratio (c), the fourth ratio (d), the first threshold value, and the second threshold value for Merchant 1 are calculated using the algorithms provided above. The first ratio (a) is compared to the first threshold value and the second ratio (b) is compared to the second threshold value. If the first ratio (a) is less than or equal to the first threshold value, the second ratio (b) is less than or equal to the second threshold value, the third ratio (c) is greater than 1, and the fourth ratio (d) is greater than 1, then debit PIN behavior exists in a particular month for Merchant 1.

In the example embodiment, Merchant 1 exhibits debit PIN routing behavior during the time periods 201607, 201608, and 201609 as shown in the below table:

| | | First | | Second | | |
|---|---|---|---|---|---|---|
| | | Threshold | | Threshold | | |
| Date | a | Value | b | Value | c | d |
| 2016 July | 1.03 | 1.05 | 0.91 | 1.60 | 4.23 | 2.81 |
| 2016 August | 0.96 | 1.04 | 0.85 | 1.59 | 1.37 | 4.48 |
| 2016 September | 1 | 1.06 | 0.89 | 1.56 | 1.01 | 5.38 |

The detection of debit PIN routing behavior is beneficial as it helps conventional EFT network processing companies identify merchants exhibiting debit PIN routing behavior to safeguard the loss of revenue to conventional EFT network processing companies. In addition, detecting debit PIN routing behavior is beneficial to both consumers and conventional network processing companies as it assists network processing companies in enforcing compliance with consumer choice proactively. For example, if some network shows debit pin routing behavior, then an alert can be generated to inform the respective merchant and take required actions.

Debit PIN routing behavior combined with other behavior patterns can also be used to categorize malicious merchants within a specific system. For example, a predictive model or clustering model can be built by finding the appropriate attributes of all the merchants who depict debit PIN routing behavior using machine learning techniques. Here, the merchants who are detected to have debit PIN routing behavior act as an input to the model.

The methods and systems described here for the detection of debit PIN routing behavior can be used as an anomaly detection model for any business that operates in a competitive market where the business has different channels of production, payment, and/or sales, for example. The methods and systems disclosed herein can detect anomalies in any of the channels with respect to the other channels using the market as a baseline.

For example, in an embodiment, a first farmer may grow three different kind of crops that are also grown by other farmers. The methods disclosed herein can detect anomaly in production amount for any one of the crops if there is a decrease in overall production for the first farmer, but not the market, indicating to him that something is wrong with production of his crop only.

In another embodiment, a group of competing coffee shops may accept payment through three modes. The methods disclosed here may be used to detect an anomaly for the coffee shop's mode of payments if there is a decline in payments for that shop but not the industry indicating loss of customers or flow in his payment acceptance mode.

In another embodiment, the methods and systems disclosed herein may be used to help analytics team minimize outliers when doing peer benchmarking for a certain industry. The methods and systems disclosed herein can be used to identify peers depicting outlier behavior so that they can be removed from a peer set, thereby allowing for the creation of a more accurate representation of the industry.

The methods and systems disclosed herein can also be applied to detect anomalies in independent business metrics, for example, outlier product sales for a business entity. For example, a profitable business where most of the products have stable sales, the methods and systems disclosed herein can detect those products that have declined sales. In another example, a profitable business where most of the product have stable sales, the methods and systems disclosed herein can be used to predict seasonality where a product has declined sales during certain times of the year.

The methods and systems disclosed herein can also be used to determine the end of life for a feature or product. Based on the usage pattern/count of features of a product (such as mobile, website, etc.) The methods and systems disclosed herein can be used to predict features or products that have declined usage; thus, indicating end of life of the feature or product.

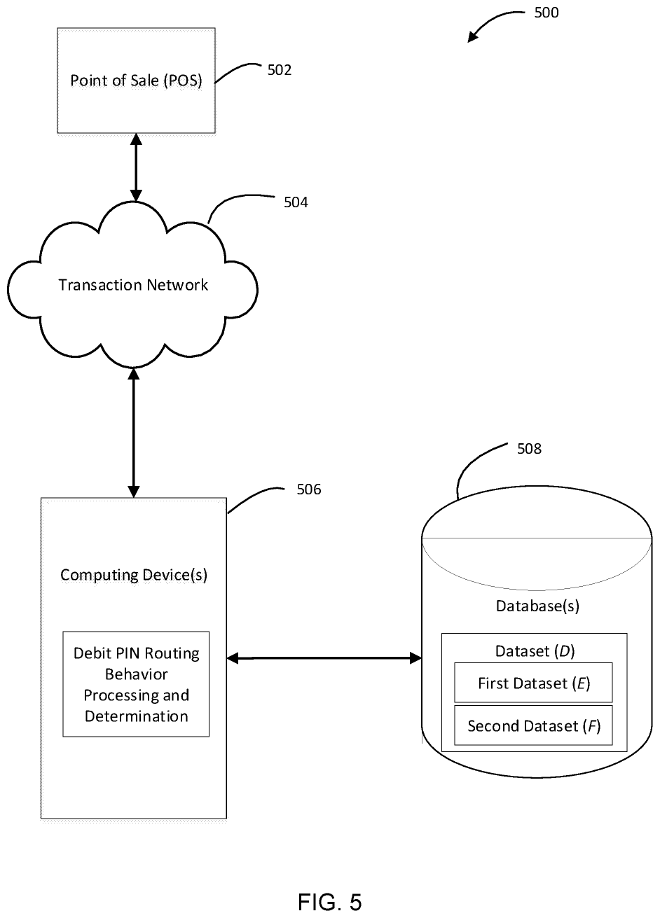

FIG. 5 is a high level schematic illustration of an electronic transaction processing system 500. The electronic transaction processing system may include one or more points of sale (POS) 502. When one or more consumers are ready to purchase their goods or services, they may be presented with the option to make a credit or debit PIN transaction at the POS 502. Depending on the type of transaction selected (debit or credit), transaction data including the transaction amount, card number, expiration date, and other information is sent to a transaction network 504. The transaction network 504 handles the processing of the transaction and may be, for example, STAR®, Pulse®, NYCE®, MAC®, MasterCard's Maestro® and Visa's Interlink®. The transaction network may also send the transaction data to one or more computing devices 506, which may store the transaction data, e.g., dataset (D), in a database 508.

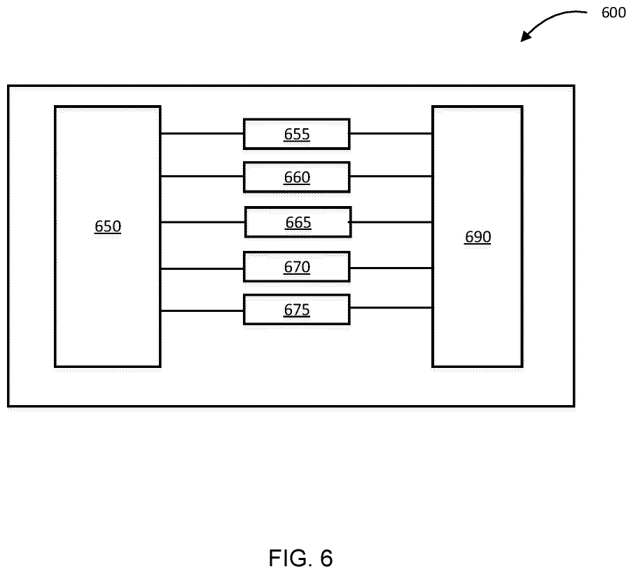

FIG. 6 may be an example computing device 600. The computing device 600 may be physically configured to interact or communicate with other computing devices via a communication network. The computing device 600 may have a processor 650 that is physically configured according to computer executable instructions. The computing device 600 may have a power supply 655 such as a battery which may be rechargeable. The computing device 600 may also have a sound and video module 660 which assists in displaying video and sound and may turn off when not in use to conserve power and battery life. The computing device 600 may also have volatile memory 665 and non-volatile memory 670 as well as internal storage 675 or external storage. The computing device 600 may have an input/output bus 690 that shuttles data to and from various user input devices such as a keyboard, mouse, speakers, or other inputs. It also may control communicating with other computing devices and system components, either through wireless or wired devices. Of course, this is just one embodiment of the computing device 600 and the number and types of computing devices 600 is limited only by the imagination.

In accordance with the provisions of the patent statutes and jurisprudence, exemplary configurations described above are considered to represent one embodiment of the disclosure. However, it should be noted that the teachings of the disclosure can be practiced otherwise than as specifically illustrated and described without departing from its spirit or scope.

The computing devices, computers, and servers described herein may be computers that may have, among other elements, a microprocessor (such as from the Intel Corporation, AMD or Motorola); volatile and non-volatile memory; one or more mass storage devices (e.g., a hard drive); various user input devices, such as a mouse, a keyboard, or a microphone; and a video display system. The user computing devices, computers, and servers described herein may be running on any one of many operating systems including, but not limited to WINDOWS, UNIX, LINUX, MAC OS, or Windows (XP, VISTA, etc.). It is contemplated, however, that any suitable operating system may be used for the present disclosure. The servers may be a cluster of web servers, which may each be LINUX based and supported by a load balancer that decides which of the cluster of web servers should process a request based upon the current request-load of the available server(s).

The computing devices, computers, and servers described herein may communicate via communications networks, including the Internet, WAN, LAN, Wi-Fi, cellular, or other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described figures, including any servers, point of sale terminals, computing devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present disclosure as described above can be implemented in the form of control logic using computer software in a modular or integrated manner. Based on the disclosure and teachings provided herein, a person of ordinary skill in the art may know and appreciate other ways and/or methods to implement the present disclosure using hardware, software, or a combination of hardware and software.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow diagram, a narrative, and/or in any other manner that provides sufficient structure for those of ordinary skill in the art to implement the recited process and its equivalents.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment. One or more features from any embodiment may be combined with one or more features of any other embodiment without departing from the scope of the disclosure. A recitation of “a”, “an” or “the” is intended to mean “one or more” unless specifically indicated to the contrary. Recitation of “and/or” is intended to represent the most inclusive sense of the term unless specifically indicated to the contrary.

Further, the figures depict exemplary embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method for:
receiving a first dataset (E), wherein the first dataset (E) is credit transaction amount for a merchant (m) during a first time period;
receiving a second dataset (F), wherein the second dataset (F) is debit PIN transaction amount for the merchant (m) during the first time period;
determining a first ratio (a) and a second ratio (b) using the first dataset (E);
determining a third ratio (c) and a fourth ratio (d) using the second dataset (F);
determining a first threshold value and a second threshold value using the first dataset (E); and
determining whether debit PIN routing behavior exists by comparing the first ratio (a) to the first threshold value and comparing the second ratio (b) to the second threshold value;
wherein the method is performed using one or more processors.

2. The method of claim 1, wherein the first time period is a period of twenty four months.

3. The method of claim 1, wherein debit PIN routing behavior exists during a second time period if the first ratio (a) is less than or equal to the first threshold value, the second ratio (b) is less than or equal to the second threshold value, the third ratio (c) is greater than 1, and the fourth ratio (d) is greater than 1 during the second time period.

4. The method of claim 3, wherein the second time period is one month.

5. The method of claim 1, further comprising:
executing a first algorithm to determine the first ratio (a), wherein the first algorithm is:
$$a = \frac{{E}_{i ( m )}}{{E}_{t - 1 ( m )}} ,$$
and
wherein Eᵢ₍ₘ₎ is a rank of the merchant (m) for a third time period i in the first dataset (E).

6. The method of claim 5, wherein the third time period i is one month.

7. The method of claim 5, wherein the merchant (m) is selected from a plurality of merchants in a category, the method further comprising:
calculating the first ratio (a) for each merchant in the plurality of merchants.

8. The method of claim 7, further comprising:
executing a first threshold algorithm to determine the first threshold value, wherein the
$$first threshold value = mean ( \frac{{E}_{i}}{{E}_{i - 1}} ) + {σ}_{\frac{{E}_{i}}{{E}_{i - 1}}} ,$$
and
wherein
$$mean ( \frac{{E}_{i}}{{E}_{i - 1}} )$$
is the mean of the first ratio (a) for the plurality of merchants, and wherein
$${σ}_{\frac{{E}_{i}}{{E}_{i - 1}}}$$
is the standard deviation of the first ratio (a) for the plurality of merchants.

9. The method of claim 1, further comprising:
executing a second algorithm to determine the second ratio (b), wherein the second algorithm is:
$$b = \frac{{E}_{i ( m )}}{{E}_{smpy ( m )}} ,$$
and
wherein Eᵢ₍ₘ₎ is a rank of the merchant (m) for a third time period i in the first dataset (E) and E_{smpy(m)} is a rank of the merchant (m) for the same time period i in a previous time frame in the first dataset (E).

10. The method of claim 9, wherein the third time period i is one month.

11. The method of claim 9 where the previous time frame is a previous 12 month period.

12. The method of claim 9, wherein the merchant (m) is selected from a plurality of merchants in a category, the method further comprising:
calculating the second ratio (b) for each merchant in the plurality of merchants.

13. The method of claim 12, further comprising:
executing a second threshold algorithm to determine the second threshold value, wherein the
$$second threshold value = mean ( \frac{{E}_{i}}{{E}_{smpy}} ) + {σ}_{\frac{{E}_{i}}{{E}_{smpy}}} ,$$
and
wherein
$$mean ( \frac{{E}_{i}}{{E}_{smpy}} )$$
is the mean of the second ratio (b) for the plurality of merchants, and wherein
$${σ}_{\frac{{E}_{i}}{{E}_{smpy}}}$$
is the standard deviation of the second ratio (b) for the plurality of merchants.

14. The method of claim 1, further comprising:
executing a third algorithm to determine the third ratio (c), wherein the third algorithm is:
$$c = \frac{{F}_{i ( m )}}{{F}_{i - 1 ( m )}} ,$$
and
wherein Fᵢ₍ₘ₎ is a rank of the merchant (m) for a third time period i in the second dataset (F).

15. The method of claim 14, wherein the third period i is one month.

16. The method of claim 1, further comprising:
executing a fourth algorithm to determine the fourth ratio (d), wherein the fourth algorithm is:
$$d = \frac{{F}_{i ( m )}}{{F}_{smpy ( m )}} ,$$
wherein Fᵢ₍ₘ₎ is a rank of the merchant (m) for a third time period i in the second dataset (F) and F_{smpy(m)} is a rank of the merchant (m) for the same time period i in a previous time frame in the second dataset (F).

17. The method of claim 16, wherein the third time period i is one month.

18. The method of claim 16, where the previous time frame is a previous 12 month period.

19. A computer-implemented system comprising:
a processor; and
a memory in communication with the processor and storing processor-issuable instructions to:
receive a first dataset (E), wherein the first dataset (E) is credit transaction amount for a merchant (m) during a first time period;
receive a second dataset (F), wherein the second dataset (F) is debit PIN transaction amount for the merchant (m) during the first time period;
determine a first ratio (a) and a second ratio (b) using the first dataset (E);
determine a third ratio (c) and a fourth ratio (d) using the second dataset (F);
determine a first threshold value and a second threshold value using the first dataset (E); and
determine whether debit PIN routing behavior exists by comparing the first ratio (a) to the first threshold value and comparing the second ratio (b) to the second threshold value.

20. The system of claim 19, wherein debit PIN routing behavior exists during a second time period if the first ratio (a) is less than or equal to the first threshold value, the second ratio (b) is less than or equal to the second threshold value, the third ratio (c) is greater than 1, and the fourth ratio (d) is greater than 1 during the second time period.
